(19) United States
(12) Patent Application Publication
(10) Pub. No.: US 2017/0328408 A1
(43) Pub. Date: Nov. 16, 2017

(54) BEARING COMPONENT & METHOD

(71) Applicant: Aktiebolaget SKF, Goteborg (SE)

(72) Inventors: Seyed HOSSEINI, Goteborg (SE); Jacek KAMINSKI, Moelnlycke (SE); Ulf SJOBLOM, Goteborg (SE)

(21) Appl. No.: 15/533,477

(22) PCT Filed: Nov. 27, 2015
(86) PCT No.: PCT/SE2015/051278

§ 371 Date: Jun. 6, 2017

(30) Foreign Application Priority Data
Dec. 16, 2014 (SE) 1451555-5

(51) Int. Cl. F16C 33/64; F16C 33/30

(52) U.S. Cl. CPC F16C 33/64; F16C 33/30; F16C 2202/04; F16C 2240/06; F16C 2220/62

(57) ABSTRACT

Bearing component providing unaffected material that has a surface, which has been subjected to a hard machining process during where the temperature of the surface did not exceed the austenitizing temperature of the unaffected material. The surface of the bearing component includes a white layer formed during the hard machining process. The white layer has a nano-crystalline microstructure that includes grains having a maximum grain size up to 500 nm. The white layer is located directly adjacent to the unaffected material of the bearing component, where no dark layer is formed during the hard machining process.

### FIELD OF THE INVENTION

The present invention concerns a bearing component comprising unaffected material, such as steel, iron or an iron-based metal having a hardness of at least 45 HRC for example, which has been subjected to a machining process, such as hard machining, e.g. turning, or hard turning. The present invention also concerns a method for manufacturing such a bearing component.

### BACKGROUND OF THE INVENTION

Hard turning is a machining process applied to metallic materials with a hardness greater than 45 HRC (which corresponds to about 450 HV1), and is typically performed after a workpiece has been heat treated. In hard turning a cutting tool describes a toolpath while a workpiece rotates. The tool's axes of movement may be a straight line, or they may be along some set of curves or angles. Usually the term “turning” is reserved for the generation of external surfaces by this cutting action, whereas this same essential cutting action when applied to internal surfaces (such as holes,) is called “boring”. Thus the phrase “turning and boring” categorizes the larger family of essentially similar processes. When turning, a piece of relatively rigid material (such as metal) is rotated and a cutting tool is traversed along 1, 2, or 3 axes of motion to produce e.g. precise diameters and tolerances.

A significant limitation of the widespread use of hard machining of metallic materials is the so-called “white layer” effect, which is a microscopic alteration of the as-machined surface of a workpiece which appears white under a Light Optical Microscope (LOM), which effect is produced in response to an extremely high thermo-mechanical load exerted at the as-machined surface of a workpiece by the cutting tool. Such white layers have a high hardness and are brittle compared to the bulk material of the workpiece. A darker region, or “dark layer” is also formed beneath the brittle and hard white layer by the action of thermo-mechanical loads on the workpiece. The dark layer is softer than both the white layer and the unaffected material. When high external loads are applied on such a triple-layered structure (i.e. a hard or very hard white layer, a soft dark layer and hard unaffected material) cracks may develop in the white layer between the white layer and the dark layer, or between the dark layer and unaffected material. When these cracks extend and connect together, flaking can occur.

A thermo-mechanically-affected workpiece surface comprising an etching-resistant white layer has conventionally been undesired because of high tensile and surface stresses associated therewith, such as reduced fatigue-resistance, lower fracture toughness, and/or reduced wear resistance of parts produced.

The location of such thermo-mechanically-affected layers on an as-machined surface of a workpiece is illustrated in FIG. 1. The micrograph shown in FIG. 1 namely shows a chemically etched, polished cross-sectional view of the typical subsurface microstructure of an as-machined workpiece observed under a Light Optical microscope (LOM) using a magnification of about 1000 times. The microstructure shows an outer surface or “white layer” (10) that was in direct contact with the cutting tool during hard turning. In addition, the microstructure shows a “dark layer” (12) beneath the white layer (10). The dark layer (12) is an over-tempered zone which has been exposed to a high temperature during the hard turning. Under the dark layer (12) is unaffected material which is the parent material that is unaffected by the machining process.

A white layer (10) as illustrated in FIG. 1 is formed during machining processes such as hard turning have negative effects on surface finish and fatigue strength of products. The white layer (10) is generally a hard phase and leads to the surface becoming brittle causing crack permeation and product failure. This is a major concern with respect to service performance especially in the aerospace and automotive industries. Due to the undesired properties of the white layer (10) as shown in FIG. 1, methods of removing, reducing or eliminating the white later (10) and the dark layer (12) are known in the prior art.

For example, U.S. patent application no. US 2003/0145694 discloses an apparatus and a method for reducing a thickness of a thermo-mechanically-affected layer on an as-machined surface of a hard metal workpiece being machined by a hard cutting tool exerting a thermo-mechanical load on a surface of the workpiece. The method involves reducing the thermomechanical load on the surface of the workpiece, and the apparatus includes a means for reducing the thermo-mechanical load on the surface of the workpiece.

U.S. patent application no. US 2013/0016938 concerns a rolling bearing of which the lifespan is increased by reducing brittle flaking and impression-induced flaking on the raceways of inner and outer races and the rolling elements. Steel containing 1.80-1.89% by weight of chrome (brittle flaking-resistant steel) is subjected to carbonitriding and then to hardening and tempering. The chrome reduces generation of white layers which are aggregates of carbon, thus reducing brittle flaking on e.g. the raceways due to the white layers. A residual austenite region that forms when the steel is hardened and tempered increases toughness of the steel surface, thus reducing impression-induced flaking due to foreign matter such as wear dust. By reducing both brittle flaking and impression-induced flaking, it is possible to extend the lifespan of the bearing, and reduce maintenance cost such as the cost for changing lubricating oil.

### BRIEF SUMMARY OF THE INVENTION

An object of the invention is to provide an improved rolling contact fatigue performance of a bearing component comprising material, such as steel, iron or an iron-based metal, having a surface that has been subjected to a hard machining process. Such a surface may have a hardness of 45 HRC (i.e. 450 HV1) or higher.

This object is achieved by ensuring that the temperature of the surface of the bearing component does not exceed the austenitizing temperature of the material, i.e. the critical phase transformation temperature of the material, during the hard machining process during the manufacture of the bearing component. The surface of the bearing component thereby comprises a white layer formed during the hard machining process, which comprises a nano-crystalline microstructure comprising grains having a maximum grain size up to 500 nm, up to 300 nm or up to 150 nm, i.e. the maximum transverse dimension, such as diameter, of all of the grains in the white layer does not exceed 500 nm, 300 nm or 150 nm. The nano-crystalline microstructure may for example comprise grains having an average grain size of 10-120 nm, or 10-100 nm or 10-80 nm. Such a nano-crystalline microstructure can be observed under a scanning electron microscope (SEM) or a transmission electron microscope (TEM) using a magnification ranging from 10,000 to 100,000 times. The white layer is located directly on the unaffected material of the bearing component, whereby no dark layer is formed during the hard machining process between the white layer and the unaffected material, i.e. the bearing component comprises a two-layer-structure consisting of a white layer and unaffected material only, rather than a three-layer-structure as shown in components according to the prior art, which three-layer structure includes a white layer, a dark layer and unaffected material (as shown in FIG. 1 of the accompanying drawings).

It should be noted that the lack of a dark layer can be determined by examining the hardness profile of a cross section of the bearing component, i.e. by measuring the hardness of the bearing component with depth below the as-machined surface. Such an examination will reveal that there is no material having a hardness less than the hardness of the unaffected material. Instead, the hardness of the white layer will, in a transition zone, decrease smoothly with depth below the as-machined surface from a maximum value at the as-machined surface to a minimum value at the unaffected material, i.e. there is no sharp transition between the hardness of white material and the hardness of the unaffected material.

It should be noted that the expression “unaffected material” as used in this document is intended to mean material that has not been affected by the hard machining process, e.g. plastic deformation. The transition zone and the unaffected material may however have been affected by a previously carried out hardening treatment, such as induction hardening, carburizing, case-carburizing, carbonitriding, nitro-carburizing or nitriding. An outermost layer of the material (for example having a thickness of 8 mm or more, or up to 8 mm, up to 7 mm, up to 6 mm, up to 5 mm, up to 3 mm, up to 2 mm or up to 1 mm) may namely have been hardened to obtain a hardness of at least 450 HV1 or more for example before the hard machining process is carried out. The expression “un-affected material” as used herein is thereby intended to mean the hardened or non-hardened parent material, before it is subjected to a hard machining process. The material at a depth of at least 300 μm below the as-machined surface of the bearing component may be considered to be unaffected material. The unaffected material may have a hardness of at least 45 HRC (equivalent to 450 HV1) or higher.

The present invention is based on the insight that if the temperature of the surface of the bearing component does not exceed the austenitizing temperature, no phase transformation will occur and plastic deformation of the workpiece material surface is simultaneously induced. A predominantly mechanically-induced, rather than a thermally-induced white layer will be formed during the hard machining process. Such a mechanically-induced white layer has a significantly different microstructure and different mechanical properties compared to the thermally induced white layers of components subjected to a hard machining process of the prior art in which the temperature of the surface of a workpiece is not supressed during a hard machining process. By limiting the temperature to below the critical austenitization temperature of the material during hard machining, a predominantly mechanically-induced white layer and no dark layer, i.e. no discernible dark layer having a hardness that is less than the hardness of the unaffected material, will be created, whereby the mechanically-induced white layer will be located directly on the unaffected material and whereby the hardness of the white layer will, in a “transition zone”, decrease smoothly with depth below the as-machined surface from a maximum value at the as-machined surface to a minimum value at the unaffected material. The mechanically-induced white layer of a bearing component according to the present invention namely comprises a homogeneous nano-crystalline microstructure comprising grains having a maximum grain size up to 500 nm. Such a white layer has improved fatigue-resistance, higher fracture toughness, and/or increased wear resistance compared to a thermally-induced white layer, and thereby enhanced rolling contact fatigue performance.

According to an embodiment of the invention the white layer comprises the same amount of retained austenite as the unaffected material of the bearing component. Alternatively, the white layer comprises less retained austenite than the unaffected material of the bearing component.

It should be noted that the expression “hard machining process” as used herein refers to any one or a combination of the following processes: turning, hard turning, boring, burnishing, mechanical grinding, milling or drilling.

The expressions “no dark layer” or “no discernible dark layer” as used herein are intended to mean that no dark layer is detectable with a Light Optical Microscope (LOM) having any conventional resolution, i.e. the bearing component according to the present invention does not comprise a dark layer having a thickness greater than 5 nm.

According to an embodiment of the invention the bearing component exhibits a hardness profile in which the hardness of the bearing component is greatest at the as-machined surface of the white layer, and decreases with depth below the as-machined surface, and whereby the hardness of the white layer is greater than the hardness of the unaffected material of the bearing component.

According to an embodiment of the invention the white layer extends up to 15 μm, up to 14 μm, up to 13 μm, up to 12 μm, up to 11 μm, up to 10 μm, up to 9 μm, up to 8 μm, up to 7 μm, up to 6 μm or up to 5 μm below the as-machined surface of the bearing component. The thickness of the white layer may for example be 1-10 μm. The white layer of a bearing component according to the present invention may be continuous or discontinuous, and it need not necessarily be of uniform thickness.

According to an embodiment of the invention the white layer has a Vickers hardness of 450-1500 (HV1) or more, and the unaffected material of the bearing component has a Vickers hardness of 450 (HV1) or more.

According to an embodiment of the invention the unaffected material has a hardness greater than or equal to 450 HV1, i.e. this is the hardness of the unaffected material prior to it being subjected to a hard machining process. Before the unaffected material is subjected to a hard machining process it may for example be austenitized and subsequently quenched to room temperature or isothermally transformed, whereby a martensitic or bainitic microstructure will be formed. The as-quenched martensitic unaffected material may then be tempered so as to produce a tempered martensitic microstructure containing below 2 volume-% retained austenite for example.

According to an embodiment of the invention the bearing component constitutes at least a part of one of the following: a ball bearing, a roller bearing, a needle bearing, a tapered roller bearing, a spherical roller bearing, a toroidal roller bearing, a ball thrust bearing, a roller thrust bearing, a tapered roller thrust bearing, a wheel bearing, a hub bearing unit, a slewing bearing, a ball screw, cylindrical roller bearing, cylindrical axial roller bearing, spherical roller thrust bearing, spherical plane bearing, or any component for an application in which it is subjected to alternating Hertzian stresses, such as rolling contact or combined rolling and sliding. The bearing component may include or constitute gear teeth, a camshaft, fastener, pin, automotive clutch plate, tool, or a die.

The bearing component may be used in automotive, aerospace, wind, marine, metal producing applications, any machine applications and/or any application that requires high wear resistance and/or increased fatigue and tensile strength. For example, the bearing component may be used in paper machines, continuous casters, fans and blowers, crushers and grinding mills, industrial transmissions, conveyors, and hydraulic motors and pumps.

The present invention also concerns a method for manufacturing a bearing component according to any of the embodiments of the invention. The method comprises the step of subjecting a surface of a workpiece of said unaffected material to a hard machining process whereby a white layer is formed during said hard machining process. The method comprises the step of controlling at least one process parameter of the hard machining process to ensure that the temperature of the surface of the bearing component does not exceed the austenitizing temperature of the unaffected material during the hard machining process, i.e. whereby the temperature at the as-machined surface is suppressed during the machining process and plastic deformation of the workpiece surface material is simultaneously induced.

According to an embodiment of the invention the at least one process parameter or a combination of several process parameters of the hard machining process is one or more of the following: cutting speed, cutting force, cooling of cutting tool (using fluid coolants for example), cooling of the surface of the bearing component, cutting tool material, cutting tool condition, cutting direction, feed rate, depth.

### BRIEF DESCRIPTION OF THE SEVERAL VIEWS OF THE DRAWING

The present invention will hereinafter be further explained by means of non-limiting examples with reference to the appended schematic figures where;

FIG. 1 shows a cross sectional view of a typical subsurface microstructure of an as-machined workpiece according to the prior art,

FIG. 2 shows the hardness profile and the grain size of an as-machined workpiece according to the prior art with depth below the as-machined surface,

FIG. 3 shows a bearing component according to an embodiment of the present invention,

FIG. 4 shows the temperature of a surface of a workpiece against cutting speed,

FIG. 5 shows a cross sectional view of a typical sub-surface microstructure of an as-machined bearing component according to the present invention, and

FIG. 6 shows the hardness profile and the grain size of a bearing component according to the present invention with depth below its as-machined surface.

It should be noted that the drawings have not necessarily been drawn to scale and that the dimensions of certain features may have been exaggerated for the sake of clarity.

### DETAILED DESCRIPTION OF THE INVENTION

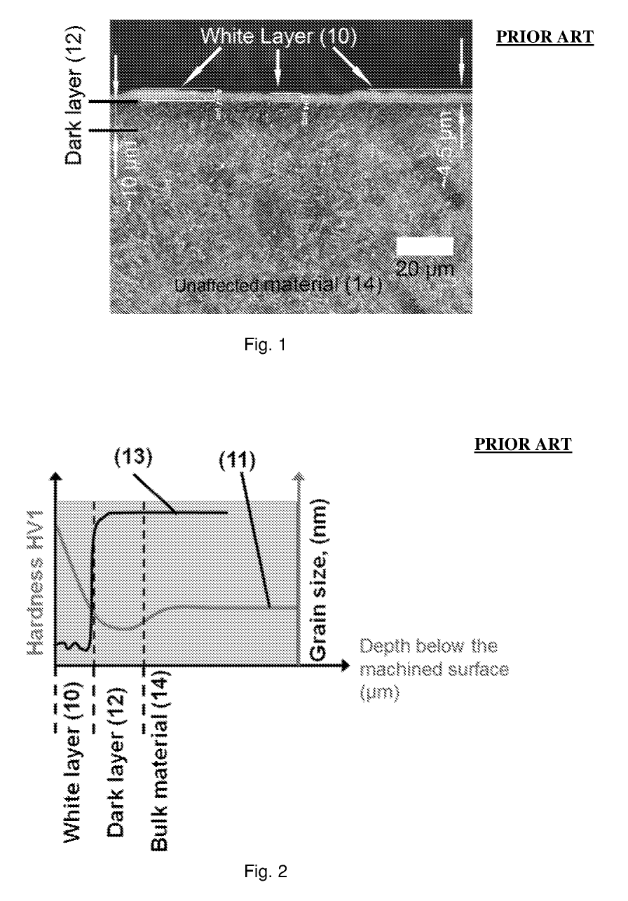

FIG. 1 shows a cross sectional view of a typical subsurface microstructure of an as-machined workpiece subjected to a hard machining process according to the prior art. The workpiece comprises a white layer 10, an underlying dark layer 12 directly adjacent to the white layer 10 and underlying unaffected material 14 directly adjacent to the dark layer 12.

The white layer 10 comprises evenly distributed carbides. The underlying dark layer 12, which is thicker than the white layer 12, also contains evenly distributed carbides. The unaffected material 14, which is unaffected by the hard machining process, comprises martensitic/bainitic needles having a length of about 2-3 μm and a width of about 0.5 μm. The martensitic/bainitic unaffected material also comprises evenly distributed carbides.

FIG. 2 shows the hardness profile 11 and the grain size 13 of an as-machined workpiece according to the prior art with depth below the as-machined surface, i.e. the uppermost surface of a thermally-induced white layer 10. It can be seen that the hardness of the dark layer 12 is lower than the hardness of the unaffected material 14, which may be detrimental to the performance of the workpiece when in use. The hardness of the dark layer 12 may be as much as 30% lower than the hardness of the unaffected material 14.

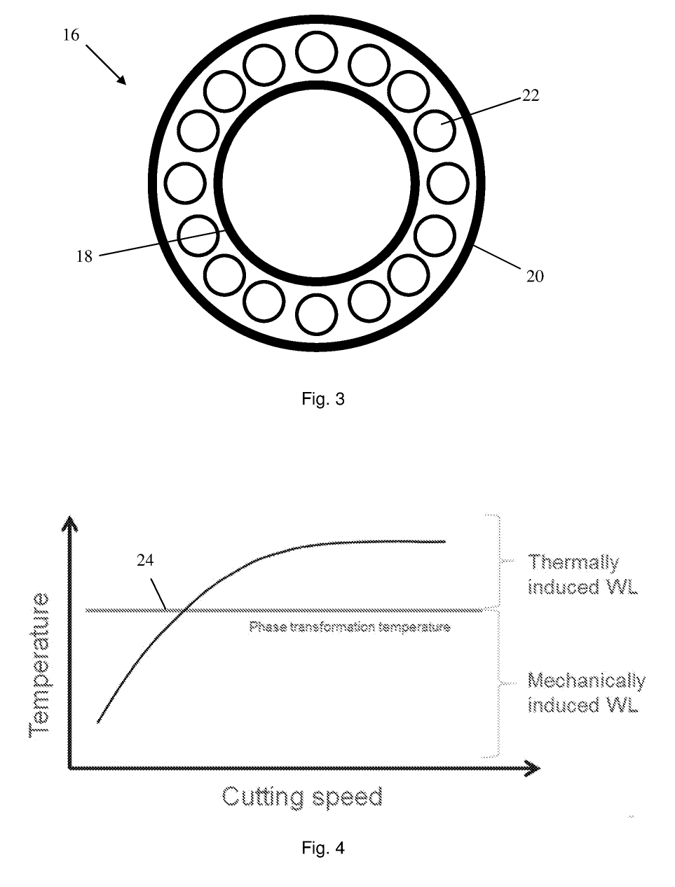

FIG. 3 shows an example of a bearing component according to an embodiment of the invention, namely a rolling element bearing 16 that may range in size from 10 mm diameter to a few metres diameter and have a load-carrying capacity from a few tens of grams to many thousands of tonnes. The bearing component 16 according to the present invention may namely be of any size and have any load-carrying capacity. The illustrated bearing 16 has an inner ring 18 and an outer ring 20 and a set of rolling elements 22.

At least part of a surface of the inner ring 18, the outer ring 20 and/or the rolling elements 22 of the rolling element bearing 16, and preferably at least part of the surface of all of the rolling contact parts of the rolling element bearing 16 may have been subjected to one or more hard machining processes during which the temperature of said at least part(s) of the surface(s) did not exceed the austenitizing temperature of the unaffected material, which may be steel having a hardness greater than or equal to 450 HV1, measured using a conventional Vickers hardness indenter, such as AISI 52100 steel for example. One or more raceways of the bearing component 16 may for example be subjected to a method according to the present invention.

The surface(s) of a bearing component 16 subjected to a hard machining process will comprise a white layer 15 that comprises a nano-crystalline microstructure comprising randomly oriented grains having a maximum grain size up to 500 nm. For example, all of the grains in the white layer 15 will have a maximum transverse dimension of 5-500 nm measured using any conventional grain size-measuring technique. The white layer 15 will be located directly on the underlying unaffected material 14 of the bearing component 16, whereby no dark layer 12 having a hardness less than the hardness of the unaffected material 14 is formed during said hard machining process.

The white layer 15 of a bearing component 16 comprising AISI 52100 steel which is subjected to such a hard machining process will comprise bcc-(a) ferrite and orthorhombic-(8) cementite carbides whereby the martensite/bainite needles of the unaffected material 14 have been reoriented along the shear direction and broken-down into elongated sub-grains through dynamic recovery. A thermally-induced white layer 10 consists instead of fcc-(y) austenite, bcc-(a) martensite, and orthorhombic-(8) cementite carbides.

If the unaffected material 14 of the bearing component 16 comprises 0 volume-% retained austenite, then the white layer 15 formed during the hard machining process will also comprise 0 volume-% retained austenite. If the unaffected material 14 of the bearing component 16 comprises 10 volume-% retained austenite, then the white layer 15 formed during the hard machining process will comprise less than 10 volume-% retained austenite, for example 5 volume-% retained austenite.

FIG. 4 is a graph of the temperature of a surface of a workpiece against cutting speed. The graph indicated the phase transformation temperature 24, i.e. the austenitizing temperature of the unaffected material 14 of the workpiece. It can be seen that the higher cutting speeds result in the temperature of the surface of the workpiece exceeding the phase transformation temperature 24, whereupon an undesired thermally-induced white layer 10 will be formed. At lower cutting speeds the temperature will be suppressed as shown in FIG. 3, whereupon no phase transformation temperature 24 of the surface material occurs at the surface constituting the workpiece; a desired mechanically-induced white layer 15 will thus be formed.

Such information representing the effect of each, or a combination of process parameters on the temperature of a surface of a workpiece subjected to a hard machining process may be obtained from experimental data or by calculation. Process parameters may then be controlled in such a way as to produce a bearing component 16 having a white layer 15 having the desired microstructure and properties.

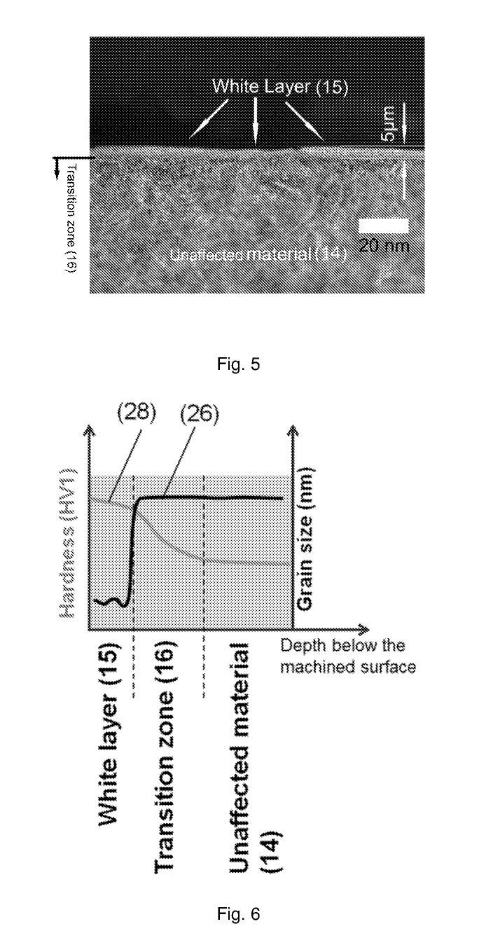

FIG. 5 shows a cross sectional view of a typical subsurface microstructure of an as-machined bearing component 16 subjected to a hard machining process according to the invention. The bearing component 16 comprises a white layer 15 located on the underlying unaffected material 14 without any discernible dark layer 12 having a hardness less than the hardness of the unaffected material therebetween. The white layer 15 comprises evenly distributed carbides. The unaffected material 14, which is unaffected by the hard machining process, comprises martensitic/bainitic needles having a length of about 2-3 μm and a width of about 0.5 μm. The martensitic/bainitic unaffected material 14 also comprises evenly distributed carbides.

FIG. 6 shows the hardness profile 26 and the grain size 28 of a bearing component 16 according to the present invention with depth below its as-machined surface. It can be seen that bearing component 16 exhibits a hardness profile in which the hardness is greatest at an as-machined surface of its mechanically-induced white layer 15. The hardness of the mechanically-induced white layer 15 is greater than the hardness of the unaffected material 14 (for example twice or three times the hardness of the unaffected material or more) and the hardness decreases smoothly with depth below the as-machined surface of the bearing component 16. The hardness of the mechanically-induced white layer 15 is namely never lower than the hardness of the unaffected material 14. The hardness decreases smoothly with depth below the as-machined surface of the bearing component 16. The thickness of the transition zone in which the hardness drops from its maximum at the as-machined surface side of the white layer 15 to its minimum at the unaffected material side of the white layer 15 can be up to 500 μm. There is namely no relatively soft dark layer 12 in between the mechanically-induced white layer 15 and the unaffected material 14. The size of the grains within the mechanically-induced white layer 15 is much lower than the size of the grains within the unaffected material 14. There is an abrupt and substantial change in grain size between the mechanically-induced white layer 15 and the unaffected material 14.

Such a mechanically-induced white layer 15 can extend from 1-15 μm below the as-machined surface of the bearing component 16 and can have a Vickers hardness of 450-1500 (HV1), whereby the unaffected material 14 of the bearing component 16 can have a Vickers hardness of 450 (HV1) or more measured using a conventional Vickers hardness test.

Further modifications of the invention within the scope of the claims would be apparent to a skilled person.

1. A bearing component comprising:
unaffected material having a surface that has been subjected to a hard machining process during which the temperature of the surface did not exceed the austenitizing temperature of the unaffected material, the surface of the bearing component includes a white layer formed during the hard machining process, wherein
the white layer includes a nano-crystalline microstructure having grains having a maximum grain size up to 500 nm and the white layer is located on the unaffected material of the bearing component, wherein
no dark layer having a hardness less than the hardness of the unaffected material is formed during the hard machining process.

2. The bearing component according to claim 1, wherein the white layer comprises the same amount of retained austenite as the unaffected material of the bearing component.

3. The bearing component according to claim 1, wherein the layer comprises less retained austenite than the unaffected material of the bearing component.

4. The bearing component according to claim 1, wherein the bearing component exhibits a hardness profile, wherein the hardness of bearing component is greatest at an as-machined surface of white layer (10), and decreases with depth below the as-machined surface, and wherein the hardness of the white layer is greater than the hardness of the unaffected material of bearing component.

5. The bearing component according to claim 1, wherein the layer extends up to 15 μm below the as-machined surface of the bearing component.

6. The bearing component according to claim 1, wherein the white layer has a Vickers hardness of 450-1500 HV1 and the unaffected material (14) of the bearing component has a Vickers hardness of 450 HV1 or more.

7. The bearing component according to claim 1, wherein the unaffected material has a hardness greater than or equal to 450 HV1.

8. The bearing component according to claim 1, further comprising that it constitutes at least a part of one of the following: a ball bearing, a roller bearing, a needle bearing, a tapered roller bearing, a spherical roller bearing, a toroidal roller bearing, a ball thrust bearing, a roller thrust bearing, a tapered roller thrust bearing, a wheel bearing, a hub bearing unit, a slewing bearing, a ball screw, cylindrical roller bearing, cylindrical axial roller bearing, spherical roller thrust bearing, spherical plane bearing, or a component for an application in which it is subjected to alternating Hertzian stresses, such as rolling contact or combined rolling and sliding and/or an application that requires high wear resistance and/or increased fatigue and tensile strength.

9. A method for manufacturing a bearing component including an unaffected material, the method comprising the step of:
subjecting a surface of a workpiece of the unaffected material to a hard machining process, wherein a white layer is formed during the hard machining process, and
controlling at least one process parameter of the hard machining process to ensure that the temperature of the surface of the bearing component does not exceed the austenitizing temperature of the unaffected material during the hard machining process.

10. The method according to claim 9, wherein at least one process parameter of the hard machining process is one or more of the following: cutting speed, cutting force, cooling of cutting tool, cooling of the at least one part of the surface of the bearing component, cutting tool material, cutting tool condition, cutting direction, feed rate, depth.
